(19) United States
(12) Patent Application Publication
(10) Pub. No.: US 2026/0005733 A1
(43) Pub. Date: Jan. 1, 2026

(54) SELF-INSTALLATION OF PHASED ARRAY ANTENNA USING AUGMENTED REALITY

(71) Applicant: VIASAT, INC., Carlsbad, CA (US)

(72) Inventor: Stephane J. PROVOST, Thonon-Les-Bains (CH)

(21) Appl. No.: 18/879,554

(22) PCT Filed: Jun. 29, 2022
(86) PCT No.: PCT/US2022/035591

§ 371 Date: Dec. 27, 2024

(51) Int. Cl. H04B 7/0408; G06T 19/00; H04B 17/23

(52) U.S. Cl. CPC H04B 7/0408; H04B 17/23; G06T 19/006

(57) ABSTRACT

Use of augmented reality to assist in visualization of characteristics of an electronically steerable antenna. An augmented reality device may include one or more sensors capable of capturing sensor data that may be analyzed to identify and/or ascertain an antenna's location and/or orientation. In turn, an augmented reality display may present information regarding the antenna which may include information regarding the orientation of the antenna relative to a target orientation. In addition, information regarding a beam of the antenna may be displayed. Further still, information regarding a communication system including a target communication device may also be presented. This may allow for demonstration and troubleshooting of operation of the electronically steerable antenna.

### BACKGROUND

Electronically steerable antennas are often used in communication systems. For example, electronically steerable antennas (e.g., phased array antennas) may allow a physically stationary antenna to track a moving communication target (e.g., a communication satellite) by steering a beam of the antenna. As such, electronically steerable antennas may be utilized in communication systems where an antenna tracks a communication satellite as it moves in the sky relative to the antenna (e.g., low-Earth orbit (LEO) systems, mid-Earth orbit systems, etc.). Tracking may even be provided in geosynchronous Earth orbit (GEO) systems due to minor variants in satellite position and/or ground movements. This may be particularly relevant when using higher frequency as any deviation from optimal aiming of the antenna may degrade performance.

However, electronically steerable antennas lack any visible moving parts. Thus, in contrast to mechanically steered antennas, electronically steered antennas steer the beam of the antenna electronically without any physical changes to the orientation or appearance of the antenna. Therefore, an observer may not be able to visualize the operation of an electronically steerable antenna. For instance, an observer may find operation of the antenna uninteresting or difficult to understand when the operation or capabilities of an electronically steerable antenna is demonstrated due to the lack of sensory feedback from the antenna. Furthermore, it may be difficult to visualize or confirm the orientation of an electronically steerable antenna and/or the position of the beam of the electronically steerable antenna because of the lack of sensory feedback. Further still, it may be difficult to troubleshoot communication problems for an electronically steerable antenna as the status of the antenna is not perceptible by a user.

### SUMMARY

The present disclosure is directed to use of augmented reality for visualization of an electronically steerable antenna. This may include determining a device location of an augmented reality device relative to Earth and resolving a device orientation of the augmented reality device relative to Earth. In addition, an electronically steerable antenna may be identified from sensor data of a field of view of a sensor of the augmented reality device. In turn, use of the augmented reality may include ascertaining an antenna location and an antenna orientation of the electronically steerable antenna based on the sensor data. The antenna location and the antennHa orientation are provided relative to the field of view of the sensor of the augmented reality device. In turn, at least one characteristic of the electronically steerable antenna may be visually presented in a display of the augmented reality device based on the ascertained antenna location and the antenna orientation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example schematic representation of an augmented reality device and an electronically steerable antenna.

FIG. 2 illustrates an example in which an electronically steerable antenna is identified from sensor data of an augmented reality device.

FIG. 3 illustrates an example of ascertaining a location and orientation of an antenna relative to an augmented reality device.

FIG. 4 illustrates an example use of an augmented reality device to assist in orienting an electronically steerable antenna.

FIG. 5 illustrates an example use of an augmented reality device to display information regarding a communication system and a beam direction of an electronically steerable antenna.

FIG. 6 illustrates an example use of an augmented reality device to determine potential obstructions or other loss of signal events at an electronically steerable antenna.

FIG. 7 illustrates an example process for use of augmented reality for visualization of an electronically steerable antenna.

FIG. 8 illustrates an example computing device capable of executing certain functionality of the present disclosure.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

The present disclosure generally relates to use of augmented reality to provide sensory feedback regarding an electronically steerable antenna. Use of augmented reality may provide benefits in a number of contexts. For example, augmented reality may be utilized to provide a richer experience to an observer when demonstrating the capabilities and/or operation of an electronically steerable antenna. In this regard, the observer, with the benefit of augmented reality, may visualize how the electronically steerable antenna is operating in a communication system. This may provide a greater understanding of the operation of the antenna and facilitate a more engaging demonstration of a communication system.

In another context, augmented reality may assist a user in setup or troubleshooting of an antenna. For example, augmented reality may be used to provide sensory feedback (e.g., visual feedback) regarding orientation and/or placement of an electronically steerable antenna. This may include determining a position and/or desired orientation of the antenna with real time feedback regarding actual placement and/or orientation of the antenna.

Further still, augmented reality may allow for visual feedback to troubleshoot issues in the communication system. For example, the augmented reality representation may help identify obstructions in a field of view of an electronically steerable antenna. Additionally or alternatively, a user may be able to identify whether continuous communications may be achieved by visualizing acquisition of signal (AOS) and loss of signal (LOS) events between the antenna and a target communication device (e.g., historic and/or future status information may be analyzed to determine if LOS occurs prior to AOS of a new target).

Furthermore, information may be provided to supplement the augmented reality display to provide additional information regarding components of a communication system other than the antenna. For instance, navigation information (e.g., ephemeris information, almanac information, heading and altitude, or other positional information regarding a communication target) for a target communication device may be provided to allow for representation of a location of one or more target communication devices in an augmented reality display. In addition, status information (e.g., a beam pointing direction) of an electronically steerable antenna may be presented to a user via an augmented reality display. That is, an antenna may communicate beam pointing direction information regarding the beam pointing direction of a beam relative to the antenna body to an augmented reality device to allow for such a beam to be visually represented in the augmented reality display even though the beam (and the beam direction) are not otherwise perceptible by an observer. The navigational information and/or beam pointing direction information represented by the augmented reality display may represent a real-time status of the communication system or may be historic and/or forecast status information relating to a previous and/or a future time period.

Accordingly, use of augmented reality in relation to an electronically steerable antenna may facilitate a more engaging experience for an observer and/or may assist in understanding the operation of a communication system that includes the electronically steerable antenna. As a result, sales or other commercial activity may be enhanced through a better understanding and demonstration of the operation of a communication system that includes an electronically steerable antenna. Further still, augmented reality information may facilitate improvements related to setup and/or troubleshooting processes that may allow for more efficient operations that reduce costs associated with setup and/or troubleshooting.

As noted above, use of augmented reality may assist in positioning and/or orienting an antenna. Antennas may be deployed in communication systems that may be used in residential and/or mobile terminals in which consistently achieving such accurate pointing may be difficult. As such, an installer or user may be responsible for mounting and positioning the antenna to provide sufficient alignment accuracy of the antenna to establish a communication link. Traditional approaches to confirming proper alignment may utilize sounds whose pitch or frequency may indicate to an installer that may physically move the antenna whether the antenna is correctly placed or incorrectly placed. However, while such sounds may provide auditory feedback regarding proper placement, they do not provide an installer feedback regarding which way to move the antenna or a real time status of the antenna relative to a desired orientation. Thus, a user may have to randomly move the antenna or systematically sweep the antenna while listening to the indicator sounds provided until proper alignment is achieved without also receiving information regarding the direction in which the antenna should be moved. Upon the antenna being correctly aligned, an auditory signal may be provided, and mechanical fasteners may be secured to maintain the antenna in a position identified by the auditory feedback. As may be appreciated, this approach does not provide compelling feedback to the user nor does this approach allow a user to understand the current orientation of the antenna relative to a desired orientation such that the user knows how to move the antenna to achieve the desired orientation. Rather, the user must simply use trial and error to achieve a desired orientation.

Electronically steerable antennas do not have moving parts such that the beam of the antenna may be manipulated electronically to steer the beam through different orientations within a beam field relative to the static antenna body. The field through which the beam may be pointed may be referred to as the beam field. Accordingly, the beam of the antenna may be electronically controlled for pointing a beam relative to the body of the antenna within the beam field. Because such control is provided electronically rather than through physical manipulation of the antenna, it may not be possible to discern which direction the antenna is pointing by simply viewing the antenna. While electronically steerable antennas may not require the same level of accuracy in pointing the antenna as is required for fixed antennas, it still may be necessary to provide the phased array antenna in a desired orientation to, for example, improve the availability of satellites within the beam field of the antenna or to ensure that consistent communication may be provided. Thus, it may be desirable to position a phased array antenna in a desired orientation to at least a sufficiently accurate degree to provide optimized positioning of the beam field.

Installation of electronically steerable antennas may be performed by relatively inexperienced or untrained users such as homeowners or the like. Regardless of who the user is installing an antenna, it may be advantageous to provide a user-friendly installation process. In this way, an inexperienced installer may achieve a desired orientation of an electronically steerable antenna and/or an experienced technician may more efficiently position and orient an antenna. Further still, electronically steerable antennas may be used in mobile antenna systems in which the platform to which the antenna is affixed may relocate and/or change orientations such that the orientation of the phased array antenna may need to be adjusted from time to time. In view of the foregoing, augmented reality may be helpful in providing additional sensory feedback related to the orientation and/or position of an electronically steerable antenna.

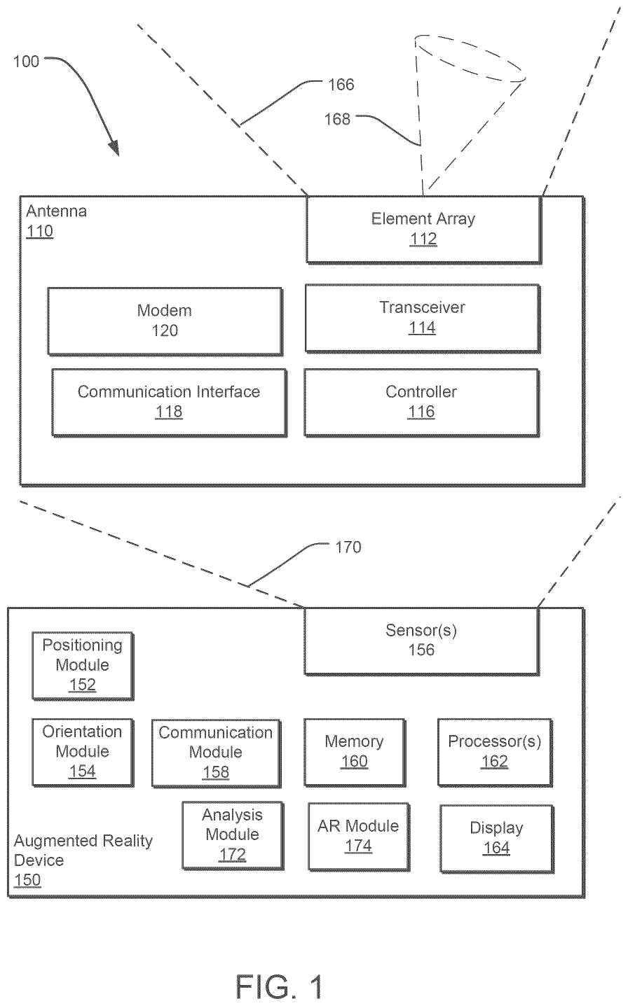

Turning to FIG. 1 an example of a system 100 is illustrated schematically. The system 100 may include an augmented reality device 150 and an electronically steerable antenna 110. The augmented reality device 150 may include one or more sensors 156. As described in detail below, the sensors 156 may capture information regarding the antenna 110. The augmented reality device 150 may be able to present to a user supplemental sensory feedback regarding the antenna 110 through an augmented reality display 164.

The augmented reality device 150 may be a computing device that includes features that facilitate presentation of information to a user through the augmented reality display 164. That is, the augmented reality device 150 may present supplemental information regarding the antenna 110 and/or other components of a communication system to a user in an augmented reality display 164 that an observer may otherwise not be capable of perceiving. Such supplemental information may be digitally created by an augmented reality module 174 and presented in the augmented reality display 164. The augmented reality device 150 may be a mobile computing device such as a smart phone, tablet, laptop or other mobile computing platform. In this regard, the augmented reality device 150 may thus generally include at least one processor 162 and at least one memory 160. The processor 162 may access the memory 160 to retrieve machine readable instructions that control the operation of the augmented reality device 150 in the manner described herein.

The augmented reality device 150 may also include a communication module 158. The communication module 158 may include one or more networking functions provided by one or more instances of hardware, software, and/or firmware such as wired and/or wireless communication chipsets. In any regard, the communication module 158 may facilitate communication between the augmented reality device and another device. The communication module 158 may provide one or more communication protocols that facilitate local communication with a device (e.g., Bluetooth or RF communication). In this regard, the communication module 158 may be operative to establish communication with the antenna 110 (e.g., a communication interface 118 of the antenna 110) to exchange information between the augmented reality device 150 and the antenna 110. As described in greater detail below, the information exchanged between the communication module 158 of the augmented reality device 150 and the communication interface 118 of the antenna 110 may include operational information regarding the antenna 110 such as beam pointing direction information. Additionally or alternatively, the communication module 158 may facilitate networked communication (e.g., via TCP/IP or other networking protocol). The communication module 158 may communicate via a local area network (LAN), a cellular network, a wide area network (WAN) such as the Internet, or other communication network. Such networked communication may facilitate receipt of information from the antenna 110 (e.g., via networked communication with the communication interface 118) or may allow for receipt of other information including communication system information including ephemeris and/or almanac information regarding one or more communication target devices.

The display 164 may be an augmented reality display such that the display 164 may present to a user information captured by one or more sensors 156 of the augmented reality device 150 (e.g., visual information) and virtual information generated by the augmented reality module 174 that is presented in the display 164. Examples of information generated by an augmented reality module 174 and displayed in an augmented reality display 164 are illustrated in more detail below. The display 164 may include a screen such as an LED display or the like. In another example, the display 164 may comprise a wearable augmented reality display. Such a wearable augmented reality display may include goggles, glasses, or another device that may be worn by a user. The wearable augmented reality display may be positioned within the field of view of a user such that augmented reality data that is digitally created may be presented to a user within the user's field of view. In this regard, rather than displaying sensor information and the augmented reality information, the wearable augmented reality display may display the augmented reality information in a relative position to the user's field of view such that the virtual information created may be overlaid on the environment perceived by the user wearing the wearable augmented reality display. Thus, a wearer's surroundings may be visible through the wearable augmented reality display, and the wearable augmented reality display may overlay the virtually created imagery such that it is perceived by a user relative to the viewable environment.

The augmented reality device 150 may include a positioning module 152. The positioning module 152 may be operative to determine a location of the augmented reality device 150 relative to a known coordinate system. In one example, the known coordinate system may be relative to a geographic coordinate system using latitude, longitude, and elevation. The positioning module 152 may include a global navigation satellite system (GNSS) module such as a Global Positioning System (GPS) module or the like. In any regard, the positioning module 152 may resolve the location of the augmented reality device 150 relative to the Earth as described by values of latitude, longitude, and elevation. Other technologies for determining the position of the augmented reality device 150 may additionally or alternatively be provided without limitation including use of terrestrial or other signals for triangulation of the position of the augmented reality device 150 relative to a known coordinate system.

The augmented reality device 150 may also include an orientation module 154. The orientation module 154 may be operative to resolve the orientation of the augmented reality device 150 with respect to the known coordinate system. Thus, the orientation module 154 may be capable of providing information regarding the orientation of the augmented reality device 150 relative to the surface of the Earth. In an example, the orientation module 154 may be able to determine an azimuth angle, an elevation angle, and a yaw angle (or heading) of the augmented reality device 150 relative to the Earth. In an example, the orientation module 154 may include an accelerometer that is able to resolve the orientation of the augmented reality device relative to the gravitational field of the Earth. Accordingly, the positioning module 152 and the orientation module 154 may provide feedback that allows for determining the location and resolving the orientation of the augmented reality device 150 such that the augmented reality device 150 may be described in the coordinate system relative to the surface of the Earth.

As noted above, the augmented reality device 150 may include one or more sensors 156. The sensor 156 may include one or more of an image sensor (e.g., camera), a time-of-flight sensor, a laser sensor (e.g., a laser rangefinder), a Lidar sensor, or any other sensor or sensor combination without limitation. The sensor 156 may include a field-of-view 170 within which the sensor 156 may be operative to capture data. In the event that a plurality of sensors 156 are provided, the respective fields of view 170 of the different sensors may overlap to provide a common field of view or the different sensors may have different fields of view 170.

In any regard, the sensor 156 may generate sensor data regarding the field of view 170. The electronically steerable antenna 110 may be positioned within the field of view 170 of the sensor 156 as schematically illustrated in FIG. 1. In turn, sensor data from the sensor 156 may be provided to the analysis module 172. As described in greater detail below, the analysis module 172 of the augmented reality device 150 may be operative to identify, locate, and/or determine the orientation of an electronically steerable antenna 110 present in the sensor data from the sensor 156. That is, the analysis module 172 may identify the antenna 110 from the sensor data. Also, the analysis module 172 may determine a location of the antenna 110 relative to the augmented reality device 150. Further still, the analysis module 172 may resolve an orientation of the antenna 110 from the sensor data. More details are provided below regarding identification, determination of relative antenna location, and determination of antenna orientation using sensor data. In an example, the captured sensor data may be displayed on the display 164 and supplemented with augmented reality information as described in greater detail below. In other examples, captured sensor data may be used to present overlaid virtual information relative to an observed environment of a user.

Turning to the electronically steerable antenna 110, the antenna 110 may include a controller 116 that may employ processors and/or memory to control the operation of the electronically steerable antenna 110. In one example, the antenna 110 may comprise a phased array antenna. Accordingly, the antenna 110 may include an element array 112. The element array 112 may include a plurality of controllable elements that may be controllable to facilitate steering of a beam 168 of the antenna through a beam field 166. In FIG. 1, the beam 168 and beam field 166 are represented in dotted lines to indicate that the beam 168 and beam field 166 are not visually perceptible to an observer of the antenna 110 using the observer's natural senses alone.

The controller 116 may be operative to control the operation of the element array 112 to control the pointing of the beam 168 of the antenna 110 within the beam field 166 as described above. In this regard, the direction in which the beam 168 of the antenna 110 points relative to the antenna body may be electronically controlled through coordination of the elements of the element array 112. As may be appreciated, because the control of the pointing direction of the beam 168 may be electronically controlled, the physical configuration or appearance of the antenna 110 may not change as the beam 168 is controlled. Thus, an observer may not have any indication as to the status of the beam pointing direction relative to the antenna 110.

The antenna 110 may also include a transceiver 114 that may send and/or receive a communication signal. The antenna 110 may also include a communication interface 118. The communication interface 118 may facilitate communication from the antenna 110 to another device. For instance, the communication interface 118 may include hardware, software, and/or firmware that facilitates communications. The communication interface 118 may support wired and/or wireless communication. One or more communication protocols may be supported that facilitate local communication with a device (e.g., Bluetooth or RF communication). As noted above, such local communication capability may be used to establish direct communication between the communication interface 118 of the antenna 110 and the communication module 158 of the augmented reality device 150 to exchange information between the antenna 110 and the augmented reality device 150. The communication interface 118 may also facilitate networked communication (e.g., via TCP/IP or other networking protocol). In this regard, the communication interface 118 may support a wired or wireless connection to a network such as a local area network (LAN), a cellular network, or a wide area network (WAN) such as the Internet (e.g., for provision of information to the augmented reality device 150 via a network with which both devices are in communication)

The transceiver 114 may facilitate two-way communication between the antenna 110 and another component of a communication system (e.g., a communication satellite or the like). As such, communication data can be received by the transceiver 114 as a forward downlink signal from a satellite received by the element array 112 of the antenna 110. The transceiver 114 can amplify and downconvert the forward downlink signal to generate modulated downlink data (e.g., a receive intermediate frequency (IF) signal) for demodulation by a modem 120. The demodulated downlink data from the modem 120 can be communicated to the communication interface 118 for communication over a network (e.g., the Internet). Furthermore, the transceiver 114 may provide uplink data from the antenna 110. As an example, uplink data may be received via the communication interface 118 and provided to the modem 120 to generate modulated uplink data (e.g., a transmit IF signal). The transceiver 114 can upconvert and then amplify the modulated uplink data to generate the return uplink signal for transmission to a satellite via the element array 112 of the antenna 110.

It may be appreciated that in order to display virtual information regarding the antenna 110 at a display 164 of the augmented reality device 150, a relative location and/or orientation of the antenna 110 may be ascertained by the augmented reality device 150. As briefly described above, the sensor(s) 156 of the augmented reality device 150 may assist in ascertaining the relative location and/or orientation of the antenna 110. In one example, one or more markers may appear on the antenna 110 in a manner that is perceptible by the sensor(s) 156. The markers may include information regarding the identity of the antenna 110 (e.g., a model identifier or the like). Further still, the markers may be provided at known locations on the antenna 110 such that the manner in which the markers are observed in the sensor data of the sensor(s) 156 may provide information regarding a relative position and/or orientation of the antenna 110. In this regard, the markers may comprise fiducial markers that allow the analysis module 172 to recognize the markers and determine the relative position and/or orientation of the antenna 110 based on an analysis of the markers as observed in the field of view 170 of the sensor 156. Such markers may include QR codes or other machine-readable indicia provided at known locations on the electronically steerable antenna 110.

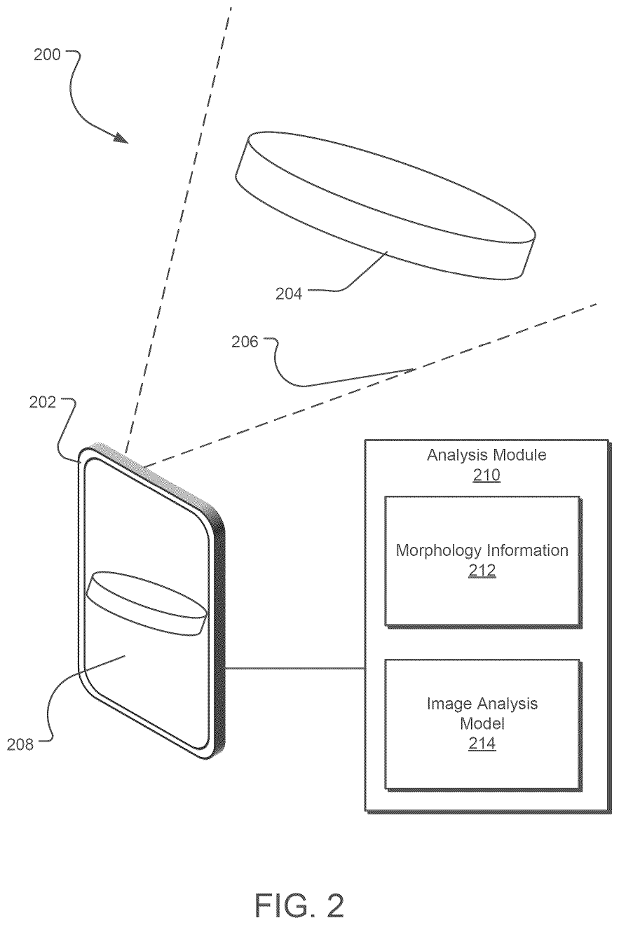

FIG. 2 illustrates another example system 200 in which an augmented reality device 202 may be used to identify an electronically steerable antenna 204 from sensor data. Specifically, the approach in FIG. 2 may leverage sensor data such that analysis of the sensor data results in identification of and antenna and/or ascertaining the location and orientation of the antenna. For example, FIG. 2 shows that the antenna 204 may be within a field-of-view 206 of a sensor of the augmented reality device 202. An augmented reality display 208 of the augmented reality device 202 may visually present the sensor data from the field of view 206 in the display 208. In the illustrated example, the sensor may include a camera such that the display 208 presents live video data that includes the field of view 206 of the sensor that includes an image of the electronically steerable antenna 204.

As described above in relation to FIG. 1, the augmented reality device 202 may include an analysis module 210. Alternatively, the analysis module 210 may be located remotely from the augmented reality device 202, and the augmented reality device 202 may be in communication with the analysis module 210 (e.g., via networked communication provided by the communication module 158). In any regard, the analysis module 210 may include known antenna morphology information 212. The known antenna morphology information 212 may comprise a database that includes information regarding appearance or physical shape of a plurality of different reference electronically steerable antennas. For example, the known antenna morphology information 212 may include a computer aided drafting (CAD) model that reflects the physical appearance of a given antenna model or design. A different CAD model may be provided for the different reference antennas. Furthermore, as the CAD models may themselves be digitally manipulated in any given orientation, the CAD models may represent training data to allow for object identification regardless of the orientation of the antenna in the sensor data.

The analysis module 210 may also include an image analysis model 214. The image analysis model 210 may be operative to apply image analysis to the sensor data captured by the augmented reality device 202. Specifically, the image analysis module 210 may apply the image analysis model 214 in which the known antenna morphology information 212 may serve as training data. In this regard, the image analysis model 214 may include a machine learning or other artificial intelligence model that may, based on the known antenna morphology information, be capable of object detection from captured sensor data. Accordingly, the image analysis model 214 may compare sensors data obtained by the sensor of the augmented reality device 202 to the known antenna morphology information to identify the electronically steerable antenna within the field of view of the sensor. In addition, the identification of an antenna may include information provided by a user such as an antenna make, model, or other information. Further still, such antenna information may be communicated directly from the antenna 204 to the augmented reality device 202.

Furthermore, the position of the antenna 204 relative to the augmented reality device 202 and/or an orientation of the antenna 204 may be determined. In one example, a distance from the augmented reality device 202 to the antenna 204 may be determined based on sensor data that measures such a distance (e.g., range finder information, Lidar data, etc.). Additionally or alternatively, the analysis module 210 may analyze the sensor data to determine location and orientation using the image analysis model 214. For instance, the greater the relative distance between the augmented reality device 202 and the antenna 204, the smaller the antenna 204 may appear relative to the augmented reality device 202 due to perspective. In turn, the size of the antenna 204 represented in the sensor data may assist in determining a distance between the augmented reality device 202 and the antenna 204. Furthermore, the orientation of the electronically steerable antenna 204 may be identified by the image analysis module 210 based upon the known antenna morphology information 212 and image analysis model 214. This may include determining the orientation using only the image analysis model 214 executed by the image analysis module 210 in the absence of any additional information such as markers or the like. Thus, object detection performed by the image analysis module 210 may provide sufficient information to ascertain a distance to the antenna 204 and an orientation of the antenna 204.

As noted above, the analysis module 210 may be executed at the augmented reality device 202 (as shown in FIG. 1) or one or more of the components of the analysis module 210 may be remote to the device 202. In one example the analysis module 210 may be executed at the augmented reality device 202 such that the processing described below occurs using a processor of the augmented reality device 202. Alternatively, the analysis module 210 may be remotely located from the augmented reality device 202. In turn, the augmented reality device 202 may communicate sensor data to the analysis module 210 via a network connection or the like. The augmented reality device 202 may, in turn, receive from the analysis module 210 information regarding the antenna 204 via the network. In still other examples, portions of the analysis module 210 may be remote and other portions may be local to the augmented reality device 202. For instance, the morphology information 212 may be stored remotely and used to train the image analysis model 214 that may be executed locally by the analysis module 210 at the augmented reality device 202.

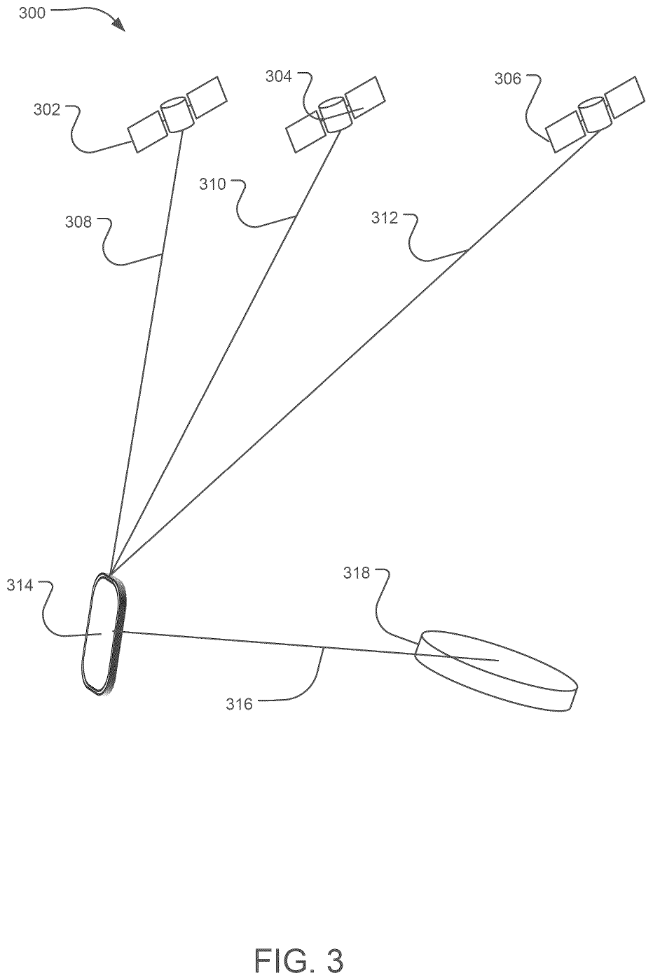

With further reference to FIG. 3, an example system 300 is depicted in which an augmented reality device 314 is used to identify and locate an electronically steerable antenna 318. The antenna 318 may be located and the orientation of the antenna 318 may be determined by an analysis module of the augmented reality device 314 as described above in relation to FIGS. 1 and 2. The augmented reality device 314 may include a positioning module 152 described above in relation to FIG. 1. In the example system 300, the augmented reality device 314 includes a GPS location module that is operative to receive a plurality of positioning signals from GPS satellites 302-306. Specifically, GPS satellite 302 may provide a positioning signal 308, GPS satellite 304 may provide a positioning signal 310, and GPS satellite 306 may provide a positioning signal 312. Additional GPS satellites may provide signals such that the augmented reality device 314 may be located relative to the surface of the Earth.

In addition, an analysis module may resolve a relative position between the augmented reality device 314 and the electronically steerable antenna 318. This relative location is illustrated by a vector 316 extending between the augmented reality device 314 and the electronically steerable antenna 318 in FIG. 3. It may be appreciated that the vector 316 in FIG. 3 represents a distance between the augmented reality device 314 and the electronically steerable antenna 318. Once the position of the augmented reality device 314 is determined and the orientation of the augmented reality device 314 is resolved, the relative position vector 316 to the antenna 318 may allow for the determination of the location of the electronically steerable antenna 318.

Returning to the discussion above, an augmented reality device that has determined a location and orientation of an antenna may generate virtual information using an augmented reality module 174 (e.g., as shown in FIG. 1) for presentation in an augmented reality display 164. This virtual information may include one or more characteristics of the electronically steerable antenna. In one example, a characteristic of the electronically steerable antenna that may be presented in an augmented reality display 164 may include an antenna axis of the antenna. The antenna axis may correspond to a boresight direction of the antenna. Thus, display of the antenna axis may help a user visualize the orientation of the antenna. Other characteristics may also be displayed including a target orientation line. The target orientation line may correspond to a desired antenna orientation.

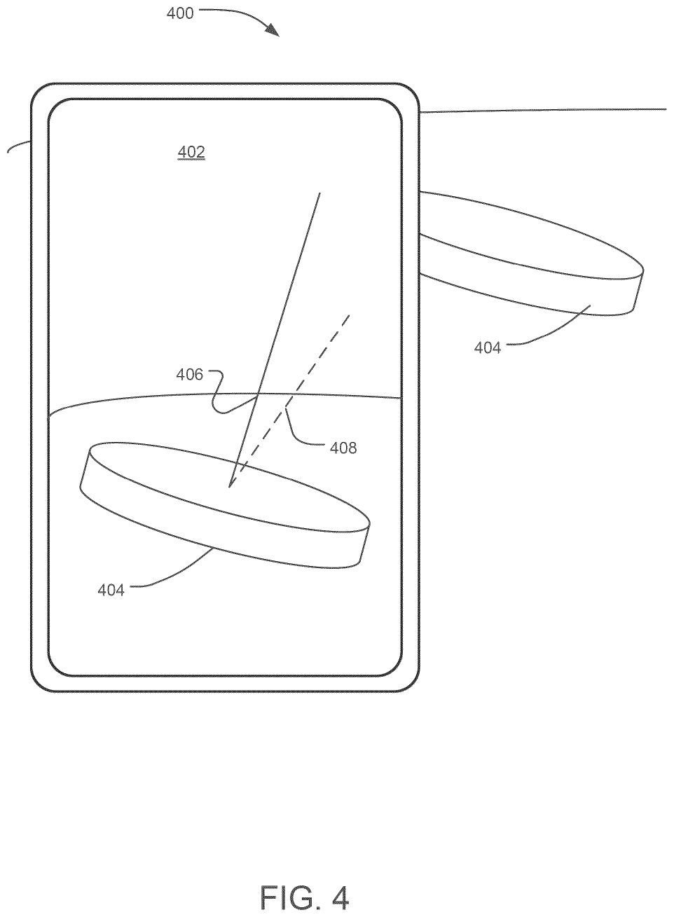

This example is further illustrated in FIG. 4. An augmented reality device 400 may include a display 402 that is capable of displaying sensor data as an image captured by a camera of the augmented reality device 400. Specifically, an electronically steerable antenna 404 may be disposed within a field of view of the sensor. Accordingly, the antenna 404 may be shown in the display 402 of the augmented reality device 400. As described above, the sensor data may be analyzed to determine the relative location and the orientation of the electronically steerable antenna 404.

A characteristic of the antenna 404 may be presented by the display 402 such that the characteristic is visually represented relative to the antenna 404 in the display 402. Specifically, in the example depicted in FIG. 4, the augmented reality device 400 may provide a visual indication regarding an orientation of the electronically steerable antenna 404. A target orientation line 408 may be shown relative to the antenna 404 in the display 402. In addition, a current orientation of the antenna 404 may be characterized as an antenna axis 406 displayed relative to the electronically steerable antenna 404 in the augmented reality display 402. As may be appreciated, the target orientation line 408 and the antenna axis 406 may be digitally rendered and displayed in the display 402 but may not be otherwise visible to an observer of the antenna 404.

The target orientation line 408 may correspond to a desired pointing direction of the axis 406 of the antenna 404. The target orientation line 408 may be at least partially based on a location of the electronically steerable antenna 318 on the Earth. Accordingly, the augmented reality module 174 may receive location information from the positioning module 152 and relative antenna position information from the analysis module 172 to locate the antenna 110. In turn the target orientation line 408 may be generated by the augmented reality module 174 at least in part based on the location of the antenna 110. As such, the analysis module 172 of the augmented reality device 400 may determine (e.g., in real time) the orientation of the electronically steerable antenna 404. The display 402 may show the current position of the antenna axis 406 relative to the target orientation line 408, which may both be determined by the augmented reality module 174. As such, a user may be provided feedback for how to move the antenna 404 to achieve the desired orientation of the antenna 404. When the antenna 404 is in a desired orientation, the axis 406 is aligned with the target orientation line 408. The augmented reality display 402 may provide further visual feedback to the user such as the axis 406 and/or the target orientation line 408 changing color, line pattern, or otherwise providing sensory feedback that the antenna 404 is aligned to a desired orientation. The sensory feedback may include a visual, auditory, tactile (e.g., haptic feedback through vibrations or the like), or other feedback to indicate the antenna 404 is in proper alignment. Unlike traditional approaches that may provide solely auditory feedback, the visual representation of the antenna axis 406 relative to the target orientation line 408 may allow the user to deliberately and directly move the antenna 404 into the proper orientation as guided by the visual feedback provided in the augmented reality display 402.

Accordingly, an augmented reality device 400 may be used to assist in orienting an electronically steerable antenna 404. This may be useful when initially deploying the antenna 404 or may be utilized in the case of a mobile antenna 404 (e.g., the antenna 404 may be reoriented upon relocating the antenna 404 to a new location). Furthermore, in the event that the electronically steerable antenna 404 is inadvertently moved from the target orientation line 408, the augmented reality device 400 may be utilized to reposition or reorient the electronically steerable antenna 404 based on the overlaid information regarding the antenna axis 406 and the target orientation line 408. The target orientation line 408 may be determined and displayed in relation to the position and location of the augmented reality device 400 relative to the antenna 404. That is, as the user moves the augmented reality device 400 relative to the electronically steerable antenna 404, the antenna axis 406 and target orientation line 408 may be updated in substantially real time such that the display 402 may display the live sensor data (e.g., video data) captured by a camera of the augmented reality device 400.

Furthermore, augmented reality may be used to demonstrate and/or troubleshoot an electronically steerable antenna as part of a larger communication system. For instance, the antenna may be operative to communicate with one or more target communication devices, which may be communication satellites, aerial communication platforms, terrestrial antennas, or the like. In this regard, an augmented reality device may receive additional information regarding other components of a communication system to further generate virtual information presented in an augmented reality display. For instance, ephemeris and/or almanac data for a communication satellites may be provided that allows an augmented reality device to present information regarding a location of a satellite to help visualize relative location of the satellite in the sky relative to an antenna. As discussed further below, this information may relate to real-time status or may represent a historic or forecast time period for visualization in an augmented reality display.

In addition, an augmented reality device may receive information from a steerable antenna regarding operation of the antenna for use in generating information for display in an augmented reality display. For instance, the controller 116 of the electronically steerable antenna may provide information regarding a beam pointing direction of a beam to the communication interface 118 for communication of the beam pointing direction information to the communication module 158 of the augmented reality device 150 such that a representation of the beam pointing direction relative to the antenna 110 may be generated by the augmented reality module 174 and provided in the augmented reality display 164. It may be appreciated that this may be useful in demonstrating the operation of the antenna. Furthermore, when combined with information regarding a communication system, this information may assist in troubleshooting operation such as by determining potential obstructions or determining availability of satellites during a transition between communication targets. In the latter regard, it may be possible to visualize whether an acquisition of signal (AOS) event is available prior to loss of signal (LOS) of a current communication target.

With returned reference to FIG. 1, it may be appreciated that the communication interface 118 of the electronically steerable antenna 110 and a communication module 158 of the augmented reality device 150 may be utilized to either receive information regarding a communication system or to exchange information between the antenna 110 and the augmented reality device 150 for generation of additional information to be displayed in an augmented reality display 164. For instance, the augmented reality device 150 may receive information regarding other components of a communication system such as target communication devices via the communication module 158. Further still, the controller 116 of the antenna 110 may provide real-time feedback regarding a pointing direction of a beam 168 formed by the element array 112 of the antenna 110. Accordingly, the beam pointing direction information provided from the antenna 110 to the augmented reality device 150 may be further used to supplement the augmented reality display 164 to present information regarding the real-time status of the beam 168 of the antenna 110.

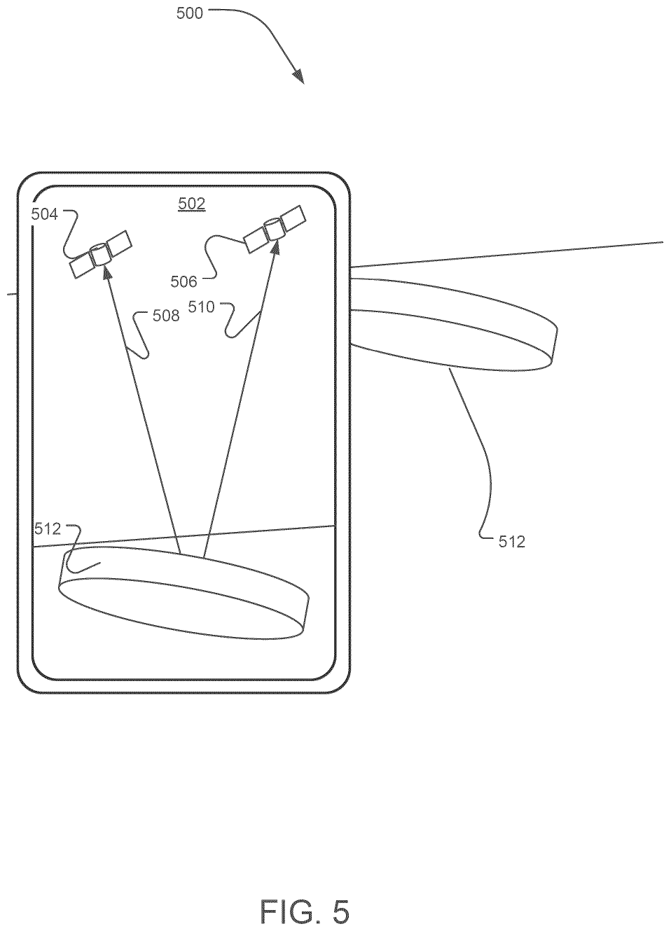

This concept is further illustrated in the example augmented reality device 500 shown in FIG. 5. Specifically, an electronically steerable antenna 512 may be captured within the field of view of a sensor of the augmented reality device 500. In turn, the electronically steerable antenna 512 may be presented in the display 502 of the augmented reality device 500. As noted above, the antenna 512 may be identified and its position and orientation may be determined from the sensor data. The augmented reality device 500 may also obtain information that may be used to supplement the augmented reality display 502 to present to a user further helpful information regarding a communication system with which the antenna 512 is interacting.

In one example, the augmented reality device 500 may be operative to obtain almanac and/or ephemeris data regarding a first satellite 504 and/or a second satellite 506. In this regard, the augmented reality device 500 may be operative to display digital representations of the satellite 504 and the satellite 506 in the augmented reality display 502. This may provide a user an indication of where in the sky the respective satellites 504/506 are located even though the satellites are not actually visible to the user with the naked eye.

Furthermore, the antenna 512 may provide beam pointing direction information to the augmented reality device 500 regarding a beam pattern such that a beam pointing direction of the antenna 512 may be represented in the augmented reality display 502. In a first example, a beam indicator 508 representative of a beam pointing direction relative to the antenna 512 may be shown. This beam indicator 508 may be provided in isolation to illustrate to an observer the status of the antenna. Further still, the beam indicator 508 may reflect the beam being directed towards the first satellite 504 as illustrated in the augmented reality display 502. In addition, another beam indicator 510 of a second beam pointing direction to a second satellite 506 may also be illustrated. Again, the beam indicators 508 and 510 presented in the augmented reality display 502 are not visible to an observer without utilization of the augmented reality device 500. In this regard, the information including the location of the satellites 504 and 506 and the beam indicators 508 and 510 may be digitally created and presented on the augmented reality display 502 to provide visual feedback to an observer.

The augmented reality device 500 may present the information shown in FIG. 5 that is representative of a current condition of the antenna 512. That is, the antenna 512 and the augmented information including the location of the satellites 504 and 506 and the beam indicators 508 and 510 may represent the current status of the antenna 512. In this regard, the augmented reality device 500 may receive real time information from the antenna 512 regarding the beam directions to allow for generation and display of the beam pointing indicators 508 and 510. The almanac and ephemeris data regarding the satellites 504 and 506 may be received from the antenna 512 and/or received via communication over a network (e.g., via the communication module 158 as shown in FIG. 1 as described above).

While the augmented reality device 500 may present real time information regarding the antenna 512 and/or satellites 504 and 506, the augmented reality display 502 may also be operative to represent historical or future time periods. In this regard, the augmented reality display 502 may be utilized to visually represent the operation of the antenna 512 over a plurality of different time periods other than the real time status.

For example, the user may be provided controls over the time period displayed in the augmented reality display. As such, the user may select the time period that is represented in the augmented reality display (e.g., using a selection menu, time slider, clock, or other user interface control). This selected time period may be in the past such that historic data regarding the satellites 504 and/or 506 is rendered in the display. Alternatively, the selected time period may be in the future such that forecast data regarding the satellites 504 and/or 506 is rendered in the display. Further still, user control over the time period displayed may be selectively applied to one or more of the satellites 504 or 506. Thus, a user may shuttle through time such that the selected time period is represented. This selection of a given time period may be applied generally to all information in the display or may be selectively applied to show historic/future positions of a given satellite (e.g., as selected by the user in the display).

In addition to providing useful illustrative information regarding the antenna 512, this information may assist in identifying or troubleshooting issues in relation to the visibility of satellites relative to the antenna 512. For instance, a user may view future time periods to identify potential obstructions between the antenna 512 and a satellite to be targeted. As an example, a user may shuttle forward in time when positioning an antenna to determine if obstructions to available communications targets occur at some future instance based on the forecast information regarding the communication targets. For example, satellite 504 and 506 represented in FIG. 5 may actually relate to a single given satellite at different times to ensure that visibility is maintained at both instances in time. Alternatively, satellite 504 and 506 may represent different satellites at or near a LOS event for satellite 506. In this regard, it may be determined whether AOS has occurred for satellite 504 prior to the LOS event for satellite 506. As such, a user may shuttle forward in time to determine if an anticipated LOS even may occur where no other communication target is available. In the event that an undesirable condition (e.g., loss of communication with all available satellites) occurs, a user may take proactive action to reposition and/or reorient the antenna to prevent the undesirable condition.

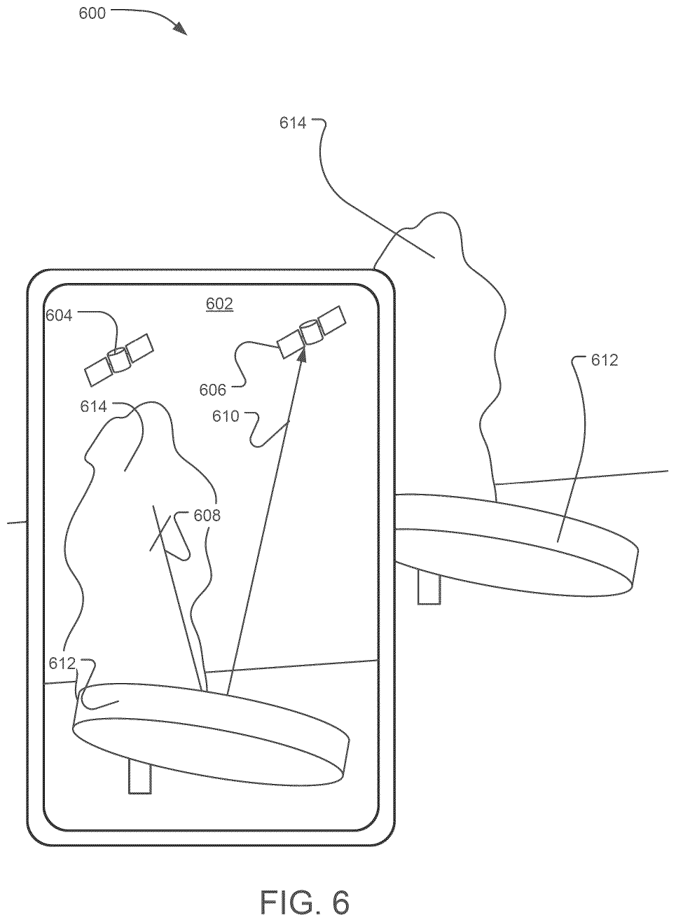

In FIG. 6, an example of an augmented reality device 600 is shown that is presenting an electronically steerable antenna 612 that is within the field of view of a sensor of an augmented reality device 600. The augmented reality device 600 is also virtually illustrating the position of a first satellite 604 and a second satellite 606 (e.g., based on received ephemeris and almanac data for the satellites 604 and 606). As described above, the virtual presentation of the information regarding the satellites 604 and 606 may represent a real-time condition, historic conditions, and/or future conditions regarding the location of the satellites 604 and 606. In this regard, it may be illustrated that a beam pointing direction 610 may allow the electronically steerable antenna 612 to communicate with the second satellite 606 without obstruction at the time period illustrated. However, the beam pointing direction 608 may indicate the beam may be obstructed such that the beam associated with beam pointing direction 608 may not provide a link with the satellite 604 in the time period illustrated. In this regard, it may be identified that the beam pointing direction 608 is obstructed from communication of the satellite 604 for the illustrated time period.

In one example, satellite 604 represents a given satellite and a first time and the satellite 606 may represent the same given satellite at a second time. Thus, the augmented reality display 602 may be utilized to determine at what time the obstruction (in the illustrated example a tree 614) would result in interruption to communication with the satellite 604 Furthermore, the information presented in the display 602 may allow for repositioning and/or reorienting the antenna 612 to provide unobstructed communication between the antenna 612 and the various positions of the satellite 604/606.

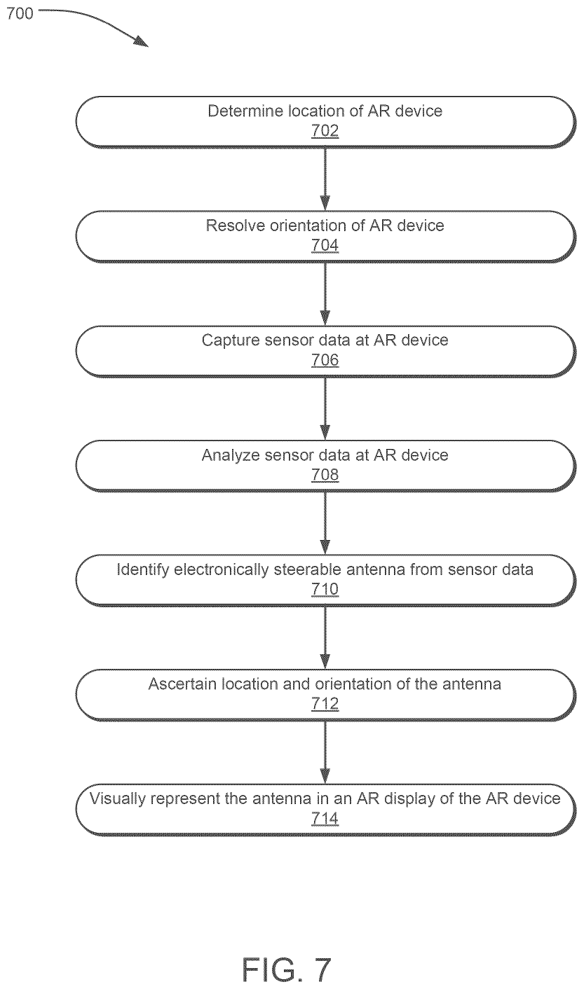

With further reference to FIG. 7, example operations 700 of a method of use of an augmented reality device for presentation of information regarding an electronically steerable antenna is illustrated. The example operations 700 may include a determining operation 702 in which a location of the augmented reality device is determined. As described above, the determining operation 702 may include use of a positioning module such as a GPS module at the augmented reality device to determine the location of the augmented reality device relative to the surface of the Earth.

In addition, a resolving operation 704 may be performed in which the orientation of the augmented reality device is resolved. As illustrated in FIG. 1, the orientation of the augmented reality device may be resolved using an accelerometer or other orientation module.

A capturing operation 706 may be performed that results in capturing sensor data at the augmented reality device. As described above, the sensor data may be captured by one or more sensors of the augmented reality device. In turn, an analyzing operation 708 may be performed in which the sensor data captured at 706 is analyzed. The analysis of the sensor data may include an image analysis module that is applied to the sensor data to perform object detection based on a trained image analysis model regarding the appearance of different antennas. Thus, an identifying operation 710 may be performed in which an electronically steerable antenna is identified from the sensor data. This may include cross-referencing morphology information.

In addition, analysis of the identified electronically steerable antenna may also be utilized in an ascertaining operation 712 in which the location and orientation of the antenna are ascertained. In this regard, the location of the antenna relative to the location of the augmented reality device may be determined by measuring a distance from the augmented reality device in a known orientation to the electronically steerable antenna. Furthermore, the orientation of the antenna may be resolved based on the sensor data to determine the orientation of the antenna based on a visual analysis from the sensor data.

In turn, a representing operation 714 may occur in which augmented reality information is visually represented in an augmented reality display of the augmented reality device.

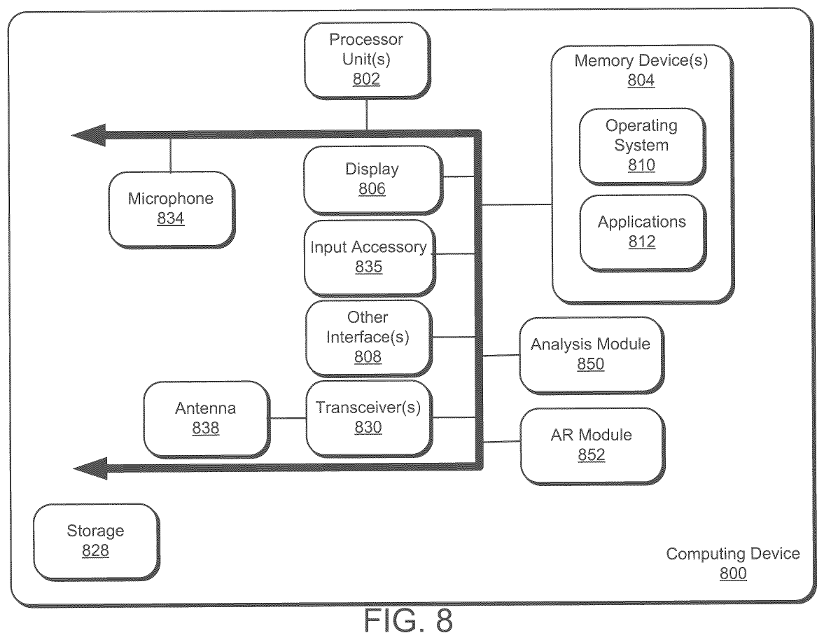

FIG. 8 illustrates an example schematic of a computing device 800 suitable for implementing aspects of the disclosed technology. For instance, the computing device 800 may comprise an augmented reality device as described above. Additionally or alternatively, the computing device 800 may include hardware, software, and/or firmware capable of providing functionality associated with the analysis module 850 and/or augmented reality module 852 described above. The computing device 800 includes one or more processor unit(s) 802, memory 804, a display 806, and other interfaces 808 (e.g., buttons). The memory 804 generally includes both volatile memory (e.g., RAM) and non-volatile memory (e.g., flash memory). An operating system 810, such as the Microsoft Windows® operating system, the Apple macOS operating system, or the Linux operating system, resides in the memory 804 and is executed by the processor unit(s) 802, although it should be understood that other operating systems may be employed.

One or more applications 812 are loaded in the memory 804 and executed on the operating system 810 by the processor unit(s) 802. Applications 812 may receive input from various input local devices such as a microphone 834, input accessory 835 (e.g., keypad, mouse, stylus, touchpad, joystick, instrument mounted input, or the like). Additionally, the applications 812 may receive input from one or more remote devices such as remotely located smart devices by communicating with such devices over a wired or wireless network using more communication transceivers 830 and an antenna 838 to provide network connectivity (e.g., a mobile phone network, Wi-Fi®, Bluetooth®). The computing device 800 may also include various other components, such as a positioning system (e.g., a global positioning satellite transceiver), one or more accelerometers, one or more cameras, an audio interface (e.g., the microphone 834, an audio amplifier and speaker and/or audio jack), and storage devices 828. Other configurations may also be employed.

In an example implementation, the computing device 800 comprises hardware and/or software embodied by instructions stored in the memory 804 and/or the storage devices 828 and processed by the processor unit(s) 802. The memory 804 may be the memory of a host device or of an accessory that couples to the host. Additionally or alternatively, the computing device 800 may comprise one or more field programmable gate arrays (FGPAs), application specific integrated circuits (ASIC), or other hardware/software/firmware capable of providing the functionality described herein.

The computing device 800 may include a variety of tangible processor-readable storage media and intangible processor-readable communication signals. Tangible processor-readable storage can be embodied by any available media that can be accessed by the computing device 800 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 800. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for use of augmented reality for visualization of an electronically steerable antenna, comprising:
determining a device location of an augmented reality device relative to Earth;
resolving a device orientation of the augmented reality device relative to Earth;
identifying an electronically steerable antenna from sensor data of a field of view of a sensor of the augmented reality device;
ascertaining an antenna location and an antenna orientation of the electronically steerable antenna based on the sensor data, wherein the antenna location and the antenna orientation are provided relative to the field of view of the sensor of the augmented reality device; and
visually representing at least one characteristic of the electronically steerable antenna in a display of the augmented reality device based on the ascertained antenna location and the antenna orientation.

2. The method of claim 1, wherein the identifying includes:
referencing known antenna morphology information for one or more reference antennas; and
comparing the sensor data obtained by the sensor of the augmented reality device to the known antenna morphology information to identify the electronically steerable antenna within the field of view of the sensor.

3. The method of claim 2, wherein the sensor comprises an image sensor and the comparing comprises applying an image analysis model to identify the electronically steerable antenna.

4. The method of claim 1, wherein the identifying includes:
recognizing markers disposed at known positions on the electronically steerable antenna.

5. The method of claim 1, wherein:
the field of view of the sensor is known relative to the device orientation of the augmented reality device;
the ascertaining includes resolving a distance between the augmented reality device and the electronically steerable antenna; and
the antenna location is determined based on the distance, the device location, and the device orientation.

6. The method of claim 1, wherein the sensor comprises an image sensor and the ascertaining comprises applying an image analysis model to identify the antenna location and the antenna orientation of the electronically steerable antenna.

7. The method of claim 1, wherein the at least one characteristic includes:
an antenna axis of the electronically steerable antenna; and
a target orientation line corresponding to a desired antenna orientation.

8. The method of claim 7, wherein the target orientation line is based on the antenna location.

9. The method of claim 7, further comprising:
visually indicating in the display when the antenna axis is aligned with the target orientation line.

10. The method of claim 1, further comprising:
receiving beam pointing direction information at the augmented reality device from the electronically steerable antenna; and
visually displaying a beam pointing direction in the display.

11. The method of claim 10, further comprising:
receiving navigation information for a target communication device with which the electronically steerable antenna has communication capability.

12. The method of claim 11, further comprising:
rendering a representation of a location of the target communication device in the display.

13. The method of claim 12, further comprising:
illustrating on the display the beam pointing direction corresponding to the beam pointing direction information relative to the representation of the location of the target communication device.

14. The method of claim 13, wherein the beam pointing direction and the location of the target communication device represent a current condition of the electronically steerable antenna and the target communication device.

15. The method of claim 14, wherein the beam pointing direction and the location of the target communication device represent at least one of a forecast or historical condition of the electronically steerable antenna and the target communication device.

16. The method of claim 15, wherein the target communication device comprises at least one satellite, and the method further comprising:
determining, based on the beam pointing direction represented in the display, potential loss of signal events between the electronically steerable antenna and the target communication device.

17. An augmented reality system for visualization of an electronically steerable antenna, the system comprising:
an augmented reality device comprising:
a positioning module operative to determine a location of the augmented reality device relative to Earth,
an orientation module operative to resolve an orientation of the augmented reality device relative to Earth,
a sensor operative to capture sensor data in a field of view of the sensor, and
an augmented reality display observable by a user; and
an analysis module operative to identify an electronically steerable antenna from the sensor data and ascertain an antenna location and an antenna orientation of the electronically steerable antenna based on the sensor data, wherein the antenna location and the antenna orientation are provided relative to the field of view of the sensor of the augmented reality device;
wherein the augmented reality device visually represents at least one characteristic of the electronically steerable antenna in the augmented reality display of the augmented reality device based on the ascertained antenna location and the antenna orientation.

18. The system of claim 17, wherein the analysis module is operative to access known antenna morphology information for one or more reference antennas and is operative to identify the antenna by comparing the sensor data obtained by the sensor of the augmented reality device to the known antenna morphology information to identify the electronically steerable antenna within the field of view of the sensor.

19. The system of claim 18, wherein the sensor comprises an image sensor and the comparing comprises applying an image analysis model to identify the electronically steerable antenna.

20. The system of claim 17, wherein the analysis module is operative to identify the antenna from the sensor data by recognizing markers disposed at known positions on the electronically steerable antenna.

21. The system of claim 17, wherein the field of view of the sensor is known relative to the device orientation of the augmented reality device and the analysis module is operative to determine a distance between the augmented reality device and the electronically steerable antenna, and wherein the antenna location is determined based on the distance, the device location, and the device orientation.

22. The system of claim 17, wherein the sensor comprises an image sensor and analysis module comprises an image analysis model to identify the antenna location and the antenna orientation of the electronically steerable antenna.

23. The system of claim 17, wherein the at least one characteristic includes:
an antenna axis of the electronically steerable antenna; and
a target orientation line corresponding to a desired antenna orientation.

24. The system of claim 23, wherein the target orientation line is based on the antenna location.

25. The system of claim 23, wherein the augmented reality display visually indicates when the antenna axis is aligned with the target orientation line.

26. The system of claim 17, wherein the augmented reality device further comprises:
a communication module in operative communication with the steerable electronic antenna to receive beam pointing direction information at the augmented reality device from the electronically steerable antenna to visually display a beam pointing direction in the augmented reality display.

27. The system of claim 26, wherein the augmented reality device is further operative to receive navigation information for a target communication device with which the electronically steerable antenna has communication capability.

28. The system of claim 27, wherein the augmented reality display renders a representation of a location of the target communication device.

29. The system of claim 28, wherein the augmented reality display illustrates the beam pointing direction corresponding to the beam pointing direction information relative to the representation of the location of the target communication device.

30. The system of claim 29, wherein the beam pointing direction and the location of the target communication device represent a current condition of the electronically steerable antenna and the target communication device.

31. The system of claim 30, wherein the beam pointing direction and the location of the target communication device represent at least one of a forecast or historical condition of the electronically steerable antenna and the target communication device.

32. The system of claim 31, wherein the target communication device comprises at least one satellite and the augmented reality device determines, based on the beam pointing direction represented in the display, potential loss of signal events between the electronically steerable antenna and the target communication device.
